(19) United States
(12) Patent Application Publication
(10) Pub. No.: US 2026/0301423 A1
(43) Pub. Date: Oct. 1, 2026

(54) UNLEARNED REGION ESTIMATION DEVICE AND INTEGRATED PROGRAM

(71) Applicant: HONDA MOTOR CO., LTD., Tokyo (JP)

(72) Inventors: Sota Kato, Hong Kong (CN); Kaname Tomite, Hong Kong (CN); Hideki Matsunaga, Wako-shi (JP)

(21) Appl. No.: 19/541,426

(22) Filed: Feb. 17, 2026

(30) Foreign Application Priority Data
Mar. 31, 2025 (CN) 202510396641.1

(51) Int. Cl. G06V 20/58; G06T 7/12; G06T 7/50; G06V 10/25

(52) U.S. Cl. CPC G06V 20/58; G06T 7/12; G06T 7/50; G06V 10/25; G06V 2201/07

(57) ABSTRACT

In order to improve detection accuracy of an obstacle or a falling object on a road, the present application discloses an unlearned region estimation device and an integrated program. A method including: a step of inferring, by a first region inference section, an object region of a falling object based on an input signal; a step of inferring, by a second region inference section, a region having a different feature from the first region inference section based on a signal same as or different from the input signal; and a step of integrating, by an inferred region integration section, the regions inferred by the first region inference section and the second region inference section, depending on a photographic scene.

### CROSS-REFERENCE TO RELATED APPLICATION

Priority is claimed on Chinese Patent Application No. 202510396641.1, filed Mar. 31, 2025, the content of which is incorporated herein by reference.

### BACKGROUND OF THE INVENTION

### Field of the Invention

The present application relates to the field of artificial intelligence technologies, and in particular, to an unlearned region estimation device and an integrated program.

### Description of Related Art

In an advanced driving assistance system (ADAS) and autonomous driving, when there is a falling object or an obstacle on a road, the falling object or the obstacle needs to be identified and avoided during traveling. However, since the number of collectable samples of data of the falling object is small, and the falling object varies, it is difficult to learn the falling object in advance.

At present, in a method for detecting a falling object or an obstacle on a road, a neural network is used to perform region division on an acquired image for detection. However, the neural network does not identify a learned object category as a falling object or an obstacle. Therefore, in the current method, it is difficult to detect a falling object or a fallen object of a learned object category, which causes missed detection and reduces detection accuracy.

### SUMMARY OF THE INVENTION

In order to improve detection accuracy of an obstacle or a falling object on a road, the present application discloses an unlearned region estimation device and an integrated program.

The technical solution of the present application is implemented as follows.

According to a first aspect, the present application provides an unlearned region estimation device, including:

a first region inference section configured to infer an object region of a falling object based on an input signal;

a second region inference section configured to infer a region having a different feature from the first region inference section based on a signal same as or different from the input signal; and

an inferred region integration section configured to integrate the regions inferred by the first region inference section and the second region inference section, depending on a photographic scene.

Optionally, the unlearned region estimation device further including: a region estimation unit, in which

the inferred region integration section includes an estimated region integrating unit,

the region estimation unit performs region estimation with two or more different features, and

the estimated region integrating unit integrates a plurality of estimated regions.

Optionally, the inferred region integration section further includes a photographic scene determination unit, in which

the photographic scene determination unit determines a scene of acquiring the input signal, and

the estimated region integrating unit integrates the estimated region based on an output from the photographic scene determination unit.

Optionally, the first region inference section performs image segmentation based on the input signal to infer an object region of the falling object, and

the second region inference section performs depth estimation based on a signal same as or different from the input signal to infer a region having a different feature from the first region inference section.

Optionally, the second region inference section performs depth estimation based on a signal same as or different from the input signal to determine a depth value corresponding to a pixel, determines a target object based on the depth value corresponding to the pixel, and predicts normal vector information corresponding to the pixel, and determines a region corresponding to the target object using the normal vector information.

Optionally, the device further including: a mixture-of-experts model configured to integrate, by the inferred region integration section, the estimated regions output by the plurality of the region inference sections, depending on a photographic scene, the plurality of region inference sections including the first region inference section and the second region inference section.

Optionally, the photographic scene determination unit determines a scene of the input signal based on a scene understanding algorithm.

Optionally, the unlearned region estimation device further including: a plurality of region inference sections, each configured to perform region estimation with two or more different features based on a signal input by itself.

Optionally, the input signal includes at least one type of signal data collected by

at least one sensor, and the at least one sensor includes at least one of an image sensor and a lidar sensor.

According to a second aspect, the present application provides an unlearned region estimation method, including:

a step of inferring, by a first region inference section, an object region of a falling object based on an input signal;

a step of inferring, by a second region inference section, a region having a different feature from the first region inference section based on a signal same as or different from the input signal; and

a step of integrating, by the inferred region integration section, the regions inferred by the first region inference section and the second region inference section, depending on a photographic scene.

Optionally, the method further including:

a step of performing, by a region estimation unit, region estimation with two or more different features; and

a step of integrating a plurality of estimated regions by an estimated region integrating unit in the inferred region integration section.

Optionally, the inferred region integration section further includes a photographic scene determination unit, and the step of integrating a plurality of estimated regions includes

a step of determining a scene of acquiring the input signal, and

a step of integrating, by the estimated region integrating unit, the estimated regions based on an output from the photographic scene determination unit.

Optionally, the step of inferring an object region of a falling object based on the input signal includes

a step of performing image segmentation based on the input signal to infer an object region of a falling object, and

the step of inferring a region having a different feature from the first region inference section based on a signal same as or different from the input signal includes

a step of performing depth estimation based on a signal same as or different from the input signal to infer a region having a different feature from the first region inference section.

Optionally, the step of performing depth estimation based on a signal same as or different from the input signal to infer a region having a different feature from the first region inference section includes

a step of performing depth estimation based on a signal same as or different from the input signal to determine a depth value corresponding to a pixel,

a step of determining a target object based on the depth value corresponding to the pixel, and predicting normal vector information corresponding to the pixel, and

a step of determining a region corresponding to the target object using the normal vector information.

Optionally, the step of determining a scene of acquiring the input signal includes

a step of determining a scene of the input signal based on a scene understanding algorithm.

According to a third aspect, the present application provides an electronic device, including: a memory; and a processor, in which

the memory stores an executable instruction, and

the processor executes the executable instruction stored in the memory to implement an unlearned region estimation method provided by the embodiment of the present application.

According to a fourth aspect, the present application provides a computer-readable storage medium storing an executable instruction, which is executed by a processor to implement an unlearned region estimation method provided by the embodiment of the present application.

According to a fifth aspect, an embodiment of the present application provides an integrated program, including a computer program or an instruction, in which the computer program or the instruction is executed by a processor to implement an unlearned region estimation method provided by the embodiment of the present application.

The present application provides an unlearned region estimation device and an integrated program, which can infer, by a first region inference section, an object region of a falling object based on an input signal; infer, by a second region inference section, a region having a different feature from the first region inference section based on a signal same as or different from the input signal; and integrate, by an inferred region integration section, the regions inferred by the first region inference section and the second region inference section, depending on a photographic scene. In an embodiment of the present application, an object region of a falling object is inferred by the first region inference section and the second region inference section based on an input signal and a signal same as or different from the input signal, respectively, to obtain regions with different features, and the region inferred by the first region inference section and the region inferred by the second region inference section are integrated by the inferred region integration section, depending on a photographic scene, so that regions with different features inferred by different inference sections are adaptively combined to estimate the object region depending on the photographic scene, thereby complementally using different feature inference methods to detect an obstacle or a falling object on a road, which reduces missed detection, and improves the detection accuracy of an obstacle or a falling object.

### BRIEF DESCRIPTION OF THE DRAWINGS

FIG. 1 is an example of a front road surface image collected by a camera of a vehicle;

FIG. 2 is a classification prediction diagram of a current neural network for the front road surface image;

FIG. 3 is a schematic flowchart of an unlearned region estimation method according to an embodiment of the present application;

FIG. 4 is an optional schematic diagram of a depth map output by a second region inference section according to an embodiment of the present application;

FIG. 5 is an optional schematic flowchart of network processing by an unlearned region estimation method according to an embodiment of the present application;

FIG. 6 is an optional schematic flowchart of network processing by an unlearned region estimation method according to an embodiment of the present application;

FIG. 7 is an optional schematic flowchart of network processing by an unlearned region estimation method according to an embodiment of the present application;

FIG. 8 is an optional schematic flowchart of network processing by an unlearned region estimation method according to an embodiment of the present application;

FIG. 9 is an optional schematic flowchart of network processing by an unlearned region estimation method according to an embodiment of the present application;

FIG. 10 is an optional schematic structural diagram of an unlearned region estimation device according to an embodiment of the present application; and

FIG. 11 is an optional schematic structural diagram of an electronic device according to an embodiment of the present application.

### DETAILED DESCRIPTION OF THE INVENTION

To make the objectives, technical solutions, and advantages of the present application clearer, the following further describes the present application in detail with reference to the accompanying drawings, the described embodiments should not be considered as a limitation on the present application, and all other embodiments obtained by a person of ordinary skill in the art without creative efforts shall fall within the protection scope of the present application.

In the following description, reference is made to "some embodiments", which describe a subset of all possible embodiments, but it is to be understood that "some embodiments" may be the same or different subsets of all possible embodiments, and may be combined with one another without conflict.

In the following description, the terms "first/second/third" are merely used to distinguish similar objects and do not represent a specific ordering for objects, and it is to be understood that the terms "first/second/third" may be interchanged in a specific order or sequence when allowed, so that the embodiments of the present application described herein can be implemented in a sequence other than that shown or described herein.

Unless otherwise defined, all technical and scientific terms used herein have the same meaning as commonly understood by a person skilled in the art to which the present application belongs. The terms used herein is only for the purpose of describing embodiments of the present application and is not intended to limit the present application.

At present, in a method for detecting a falling object or an obstacle on a road, a neural network is used to perform region division on an acquired image for detection.

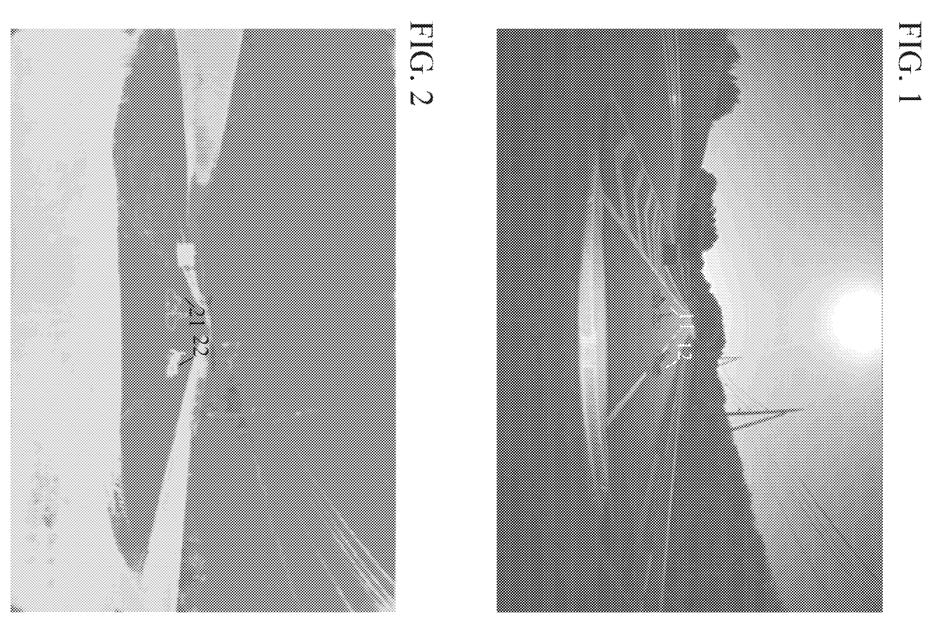

However, the neural network does not identify a learned object category as a falling object or an obstacle. Exemplarily, in a front road surface image collected by a camera of a vehicle as illustrated in FIG. 1, the obstacle present on the road is a bicycle 11 and a bicycle 12. The neural network has learned features of a bicycle, and thus will identify the bicycle 11 with obvious appearance features, classify pixels of the bicycle 11 as a bicycle in an output classification prediction diagram as illustrated in FIG. 2, and form an image region 21 classified as a bicycle in FIG. 2. Since an appearance of the bicycle 12 is quite different from an appearance of a bicycle learned by the neural network, the bicycle 12 will be considered as a falling object or an obstacle, and an image region 22 classified as an obstacle in FIG. 2 is formed. It can be seen that in the current method, it is difficult to detect a falling object or a fallen object in a learned object category, which causes missed detection, reduces detection accuracy, and further reduces safety of autonomous driving or assisted driving.

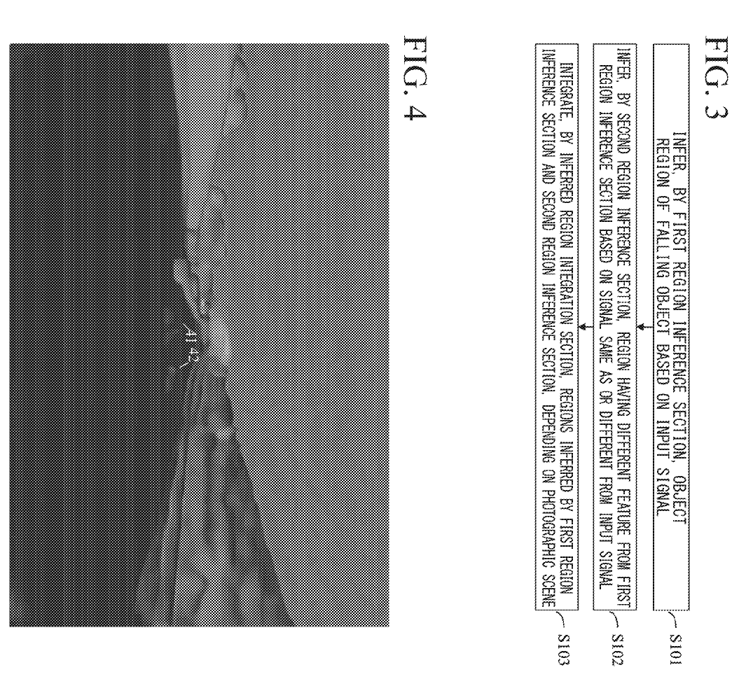

In order to improve detection accuracy of an obstacle or a falling object on a road, an embodiment of the present application discloses an unlearned region estimation device and an integrated program. An unlearned region estimation method in the embodiment of the present application may be illustrated in FIG. 3, and includes S101 to S103 as follows.

S101. An object region of a falling object is inferred by a first region inference section based on an input signal.

S102. A region having a different feature from the first region inference section is inferred by a second region inference section based on a signal same as or different from the input signal.

In the embodiment of the present application, the input signal may include an image collected by an image sensor or point cloud data scanned by a laser radar. The first region inference section or the second region inference section may include a neural network for an image segmentation task, or a neural network for depth estimation, or any one of at least one neural network for target detection based on a signal of at least one sensor. It should be noted that the first region inference section and the second region inference section are neural networks that infer an object region of a falling object on a road by different feature inference methods. That is, the first region inference section and the second region inference section are neural networks for different feature processing processes.

In some embodiments, taking the first region inference section as a neural network of an image segmentation task as an example, the first region inference section may perform feature extraction on an image, and distinguish, based on an extracted feature, at least one image region corresponding to at least one object in the image, and output a category corresponding to each pixel point in the image, thereby implementing the image segmentation task. Exemplarily, the first region inference section may perform pixel-level semantic segmentation on an image, and output a semantic segmentation image, which includes a semantic category label corresponding to each pixel point in the input image. Exemplarily, the first region inference section may include a neural network of a Mask2Former structure.

The first region inference section finishing the image segmentation task may identify and divide an image region corresponding to a learned object from the input image. When the image includes an object that has not been learned by the first region inference section, the first region inference section may segment out an image region corresponding to the object that has not been learned, and mark a category of a pixel included in the image region as representing an unlearned category (or represent abnormal category). That is, it is possible to detect, by the first region inference section, an object region corresponding to an unlearned object in the image, thereby detecting an unlearned obstacle or falling object appearing on the road.

In the embodiment of the present application, a signal processed by the second region inference section may include a signal same as or different from the input signal of the first region inference section. Exemplarily, the first region inference section and the second region inference section may be used to process the same image, or the first region inference section and the second region inference section may be used to separately process images collected on the road at different viewing angles.

In some embodiments, taking the second region inference section as a neural network for performing a depth estimation task as an example, the second region inference section performs depth estimation on the input image, and outputs depth information corresponding to each pixel in the image, so that it is possible to identify a three-dimensional object in the image based on the depth information corresponding to each pixel, and then determine the three-dimensional object present on the road, thereby implementing detection on an obstacle or a falling object on the road. Exemplarily, the depth information corresponding to a pixel may include a relative distance between the pixel and a photographing source.

Exemplarily, the second region inference section may include a monocular vision or binocular vision-based depth estimation network. The second region inference section may output a depth map based on the depth information of each pixel. Taking the second region inference section performing depth estimation on FIG. 1 as an example, the output depth map may be as illustrated in FIG. 4. Three-dimensional objects 41 and 42 on a traveling route of a vehicle can be detected or identified based on the depth information corresponding to each pixel in FIG. 4, thereby detecting an obstacle or a falling object on the traveling route.

In the embodiment of the present application, the second region inference section outputs a region having a different feature from the region output by the first region inference section. Exemplarily, the object region output by the first region inference section is a region representing a semantic feature of a falling object. The region output by the second region inference section is a region representing a depth feature of a falling object. Alternatively, the first region inference section and the second region inference section may perform target detection on two-dimensional images and three-dimensional point cloud data collected by different sensors, respectively, and output different bounding boxes to represent object regions of falling objects with different features.

S103. The regions inferred by the first region inference section and the second region inference section are integrated by the inferred region integration section depending on a photographic scene.

In the embodiment of the present application, the inferred region integration section is used to integrate the regions inferred by the first region inference section and the second region inference section, depending on a photographic scene. The photographic scene includes a scenario factor for signal collection of a falling object. Here, the scenario factor may include an object feature factor of a collected object, that is, a falling object, or a collection environment factor in which signal collection is performed. In some embodiments, the photographic scene may include an appearance of a falling object (for example, shape and/or size of falling object), a distance between the falling object and the electronic device, or a photographic environment in which the falling object is currently located (for example, weather or light brightness). The selection is specifically performed according to an actual situation, and is not limited in the embodiment of the present application.

In some embodiments, the inferred region integration section may include a photographic scene determination unit. Exemplarily, the photographic scene determination unit may include a neural network for determining a photographic scene, and the input signal of the inferred region integration section may be a signal same as the first region inference section and/or the second region inference section, which is used for determining, by the photographic scene determination unit in the inferred region integration section, a photographic scene using a scene understanding algorithm based on a signal input to the first region inference section and/or a signal input to the second region inference section. Alternatively, the inferred region integration section may also be connected to an independent photographic scene determination unit. Exemplarily, the input signal of the inferred region integration section may be the output signal of the photographic scene determination unit, and the input signal of the photographic scene determination unit may be a signal same as the first region inference section and/or the second region inference section, so that the photographic scene may be determined by using the scene understanding algorithm based on the signal input to the first region inference section and/or the signal input to the second region inference section, and output to the inferred region integration section.

In the related art, for the problem of merging two different network inference results into one, a simple threshold is generally used for merging. However, since the threshold belongs to hyperparameters of the neural network, it is difficult to determine a threshold suitable for merging. In addition, since the input environment is different, and an applicable threshold is also different, a simple threshold merging method in the related art is generally not applicable to an actual application.

In the embodiment of the present application, the inferred region integration section may be implemented in a form of a neural network. The inferred region

integration section may be trained together with the untrained first region inference section and the untrained second region inference section, or the inferred region integration section may be trained based on the pre-trained first region inference section and the pre-trained second region inference section. The selection is specifically performed according to an actual situation, and is not limited in the embodiment of the present application. In a network training process, the inferred region integration section learns optimal parameters for integrating the region output by the first region inference section and the region output by the second region inference section in various photographic scenes, so that after the training is completed, the inferred region integration section can be used to automatically perform optimal integration on the region inferred by the first region inference section and the region inferred by the second region inference section, depending on the photographic scene, thereby implementing accurate detection on a region where a falling object or an obstacle is located. In addition, the optimal parameter of the region integration may be adaptively adjusted in different photographic scenes, so that the system robustness is improved.

It can be understood that in the embodiment of the present application, an object region of a falling object is inferred by the first region inference section and the second region inference section based on an input signal and a signal same as or different from the input signal, respectively, to obtain regions with different features, and the region inferred by the first region inference section and the region inferred by the second region inference section are integrated by the inferred region integration section depending on a photographic scene, so that regions with different features inferred by different inference sections are adaptively combined to estimate the object region depending on the photographic scene, thereby complementally using different feature inference methods to detect an obstacle or a falling object on a road, which reduces missed detection, and improves the detection accuracy of an obstacle or a falling object.

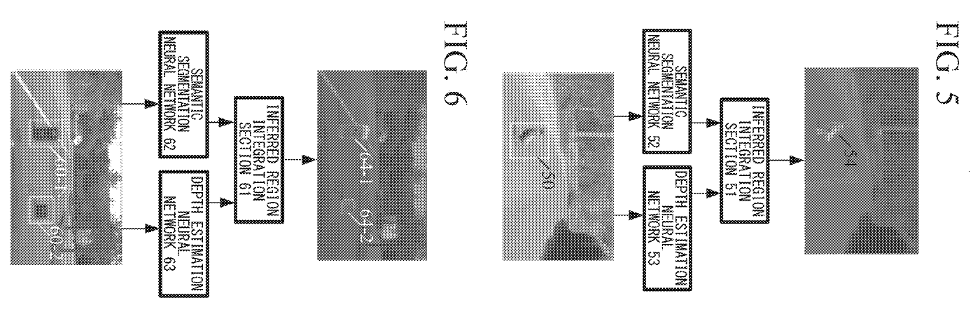

In some embodiments, a neural network model including the first region inference section, the second region inference section, and the inferred region integration section may be a mixture-of-experts model (MoE). The first region inference section and the second region inference section are equivalent to expert models in the MoE, and the inferred region integration section is equivalent to a gating network or a gate model in the MoE. The gating network or the gate model is used to balance and merge outputs of the expert models, determine a weight of each expert model on final prediction, and merge the obtained results. Exemplarily, the first region inference section may include a semantic segmentation neural network, and the second region inference section may include a depth estimation neural network. When a falling object on a road is an object 50 in FIG. 5, since a difference between appearances of the object 50 and an object learned by a semantic segmentation neural network 52 is large, the inferred region integration section 51 may allocate a higher weight to a region output by the semantic segmentation neural network 52 between the semantic segmentation neural network 52 and a depth estimation neural network 53, integrate regions output by the semantic segmentation neural network 52 and the depth estimation neural network 53 according to the allocated weights, and output a finally determined object region 54 of the falling object. When the falling object on the road is an object 60-1 and an object 60-2 in FIG. 6, since a difference between appearances of the object 60-1 and the object 60-2 and an object learned by a semantic segmentation neural network 62 is relatively small, an inferred region integration section 61 may allocate a higher weight to a region output by a depth estimation neural network 63 between the semantic segmentation neural network 62 and the depth estimation neural network 63, integrate regions output by the semantic segmentation neural network 62 and the depth estimation neural network 63 according to the allocated weights, and output finally determined object regions 64-1 and 64-2 of the falling object.

In some embodiments, the photographic scene may include a shape and/or a size of the falling object.

In some embodiments, the inferred region integration section may adaptively select feature information output by the region inference section with a high weight in units of pixels based on the shape and/or the size of the falling object from the region output by the first region inference section and the region output by the second region inference section, use a weighted sum to perform integration, and output the object region of the falling object.

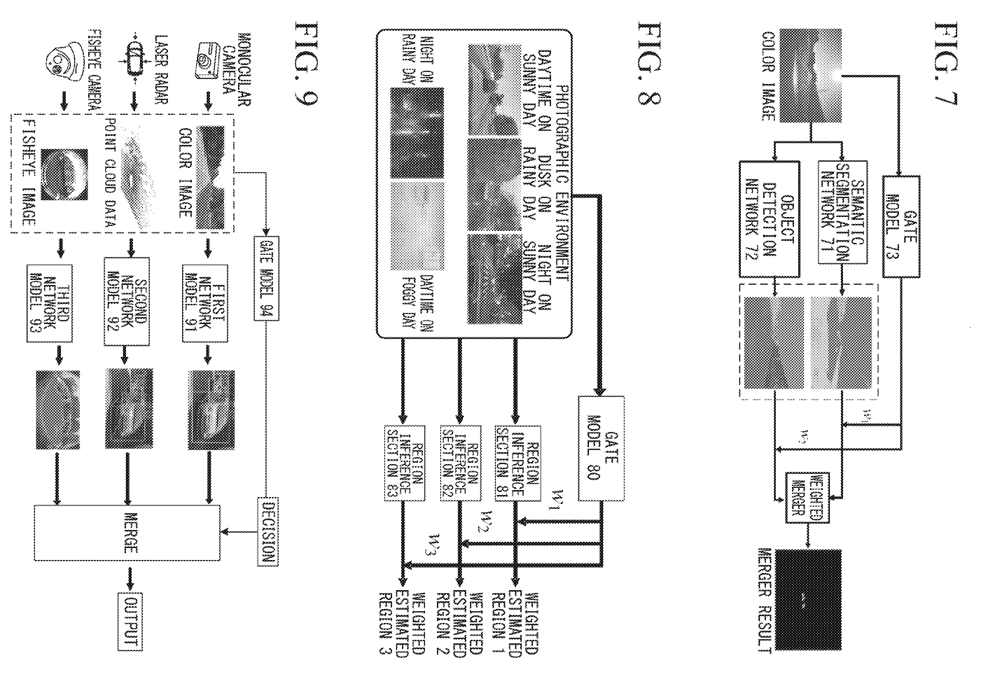

Exemplarily, as illustrated in FIG. 7, the input signal of the first region inference section and the signal of the second region inference section may be a same color (RGB) image. The first region inference section may include a semantic segmentation network 71. The semantic segmentation network 71 determines, by semantic segmentation, a pixel label corresponding to each pixel in the RGB image, and the pixel label represents whether the pixel belongs to a pixel of a falling object (unlearned object). In some embodiments, the pixel label may include an anomaly score for the pixel. Exemplarily, an anomaly score corresponding to a pixel represents a probability that the pixel is a falling object. The greater the difference in appearance between the pixel and the object category learned by the semantic segmentation network, the higher the probability that the pixel is a falling object. Here, the pixel label corresponding to each pixel in the RGB image is regarded as a pixel label image output by the semantic segmentation network.

As illustrated in FIG. 7, the second region inference section may include an object detection network 72 based on monocular depth estimation and normal vectors.

The object detection network 72 obtains a depth value corresponding to each pixel in the RGB image using a monocular depth estimation (such as MonoDepth depth estimation) algorithm, and determines depth information corresponding to each pixel based on the depth value. In some embodiments, the object detection network 72 may predict normal vector information corresponding to each pixel in the image, and exemplarily, the normal vector information may include a surface normal vector of an object where the pixel is located. A target object may be preliminarily determined by using the depth value corresponding to each pixel, and a region corresponding to the target object may be further extracted using the normal vector information. That is, depth information corresponding to each pixel may be determined based on the normal vector information and the depth value, thereby determining a depth information image output by the object detection network 72, where the depth information image includes an estimated region obtained by the depth estimation of the second region inference section. In this manner, the depth value is post-processed or optimized by using the surface normal vector. For example, the depth value may be optimized using the normal vector information through smoothness constraint and surface continuity constraint, to ensure consistency between the surface normal vector and the depth value.

As illustrated in FIG. 7, the inferred region integration section may use a neural network (for example, UNet) with an encoder-decoder structure, such as the gate model 73. Exemplarily, in a training process, the gate model 73 may obtain, by supervised learning, a weight w₁ corresponding to the semantic segmentation network 71 and a weight w₂ corresponding to the object detection network 72. In this way, the pixel label and the depth information may be subjected to weighted merger by w₁and w₂, respectively, in units of pixels by the gate model 73 based on a pixel label image output by the semantic segmentation network 71 and a depth information image output by the object detection network 72, and a merger result is output, where the merger result includes the finally determined object region of the falling object.

It can be understood that, in the embodiment of the present application, an object that is not included in learning is considered as a falling object and is identified, so that a large quantity of learning data of different falling objects is not required at all. Meanwhile, object detection information based on depth estimation is integrated, thereby avoiding a problem that an object similar to an object learned in an unlearned object detection model is incorrectly detected, and improving detection accuracy of an obstacle or a falling object.

In some embodiments, the first region inference section and the second region inference section may be region inference sections among a plurality of region inference sections, and the plurality of region inference sections may further include other region inference sections. The plurality of region inference sections may output estimated regions with a plurality of different features. The inferred region integration section may further integrate regions with a plurality of different features output by the plurality of region inference sections. Exemplarily, the inferred region integration section performs integration on a plurality of estimated regions, thereby performing region estimation with two or more different features, and determining a final object region of the falling object.

In some embodiments, the photographic scene may include a photographic environment. Exemplarily, the photographic environment may include a weather environment and/or a light environment during photographing, for example, a sunny day, a night, a daytime, or a rainy day. The selection is specifically performed according to an actual situation, which is not limited in the embodiment of the present application.

In some embodiments, the inferred region integration section may adaptively select an output of a region inference section with high computing efficiency from the plurality of region inference sections depending on the photographic scene, thereby implementing high performance prediction. Each of the plurality of region inference sections may be a lightweight model with high computing efficiency (for example, MobileNet), and each region inference section is good at detection on a falling object in at least one photographic environment. Here, the inferred region integration section may be a lightweight model (for example, gate model) with the same structure, and the inferred region integration section may automatically learn, in a training process, a photographic environment in which each region inference section in the plurality of region inference sections is good at processing, so that in different photographic environments, the inferred region integration section may output a weight corresponding to each region inference section in the photographic environment. Exemplarily, a corresponding weight in the photographic environment may represent an importance degree (which may be probability value) of an output result of the corresponding inferred region integration section in the photographic environment. Exemplarily, as illustrated in FIG. 8, the gate model may output a weight corresponding to each region inference section for an image in each photographic environment based on various photographic environments (for example, daytime on sunny day, dusk on rainy day, night on sunny day, night on rainy day, or daytime on foggy day), and learned photographic environments in which each region inference section (for example, region inference section 81, region inference section 82, and region inference section 83) is good at processing. For example, for an image under an environment of the daytime on a sunny day, the weight w₁ corresponding to the region inference section 81, the weight w₂ corresponding to the region inference section 82, and a weight w₃ corresponding to the region inference section 83 are output. In some embodiments, setting the weight to zero may represent that the estimated region output by the corresponding region inference section is not used. The estimated region output by each region inference section is weighed based on the weight corresponding to the region inference section, and the plurality of weighted estimated regions corresponding to the plurality of region inference sections are merged. Exemplarily, the estimated region output by the region inference section 81 is weighted by w₁ to obtain a weighted estimated region 1 corresponding to the region inference section 81, the estimated region output by the region inference section 82 is weighted by w₂ to obtain a weighted estimated region 2 corresponding to the region inference section 82, the estimated region output by the region inference section 83 is weighted by w₃ to obtain a weighted estimated region 3 corresponding to the region inference section 83, the weighted estimated region 1, the weighted estimated region 2, and the weighted estimated region 3 are subjected to integration merger, and an object region of a falling object in the photographic scene is determined according to a merger result, so that detection on a falling object in various photographic environments can be processed.

It should be noted that, in the case where the photographic scene includes the photographic environment, the MoE model may also be used to implement the plurality of region inference sections and the inferred region integration section, where the plurality of region inference sections are equivalent to the expert models in the MoE model, and the inferred region integration section is equivalent to the gate model or the gating network in the MoE model.

It can be understood that, as compared with the related art in which a large model is usually used to implement detection on an object in a multi-photographic environment, use of a plurality of small models in the embodiment of the present application can improve overall computing efficiency, thereby improving the detection efficiency of a falling object. Since the optimal model output can be selected according to the input photographic environment, the threshold need not be reset. In addition, accuracy degradation due to a change in the photographic environment may also be prevented, and more robust detection is implemented.

In some embodiments, the photographic scene may include a distance between a falling object and an electronic device. The plurality of region inference sections may include a plurality of region inference sections corresponding to a plurality of sensor types. Exemplarily, the sensor type may include an image sensor, such as a camera, a fisheye camera, and a laser radar. Correspondingly, the input signal may include an RGB image from a camera, point cloud from LiDAR, an image from a fisheye camera, and a sensor signal corresponding to a plurality of sensor types such as 4Dladar. For a sensor signal of each sensor type, target detection on a falling object is performed on the sensor signal by the corresponding region inference section in the plurality of region inference sections, and a target detection region corresponding to each region inference section is output as the estimated region corresponding to each region inference section. It may be understood that target detection is performed on different input signals, formats of target detection regions output by different region inference sections may be different, for example, a target detection region corresponding to an RGB image of a camera may be a two-dimensional (2 Dimension, 2D) target detection box and a three-dimensional (3 Dimension, 3D) target detection box, and a target detection region corresponding to radar point cloud data may be a 3D target detection box. In the embodiment of the present application, the inferred region integration section is used to integrate the target detection regions output by different region inference sections, thereby determining the final object region of the falling object.

In some embodiments, the inferred region integration section may automatically determine importance degrees of different sensor signals based on the distance between the falling object and the electronic device, so as to determine a weight corresponding to each region inference section, and integrate weights of a plurality of target detection regions output by the plurality of region inference sections based on the weight corresponding to each region inference section to determine the final object region of the falling object.

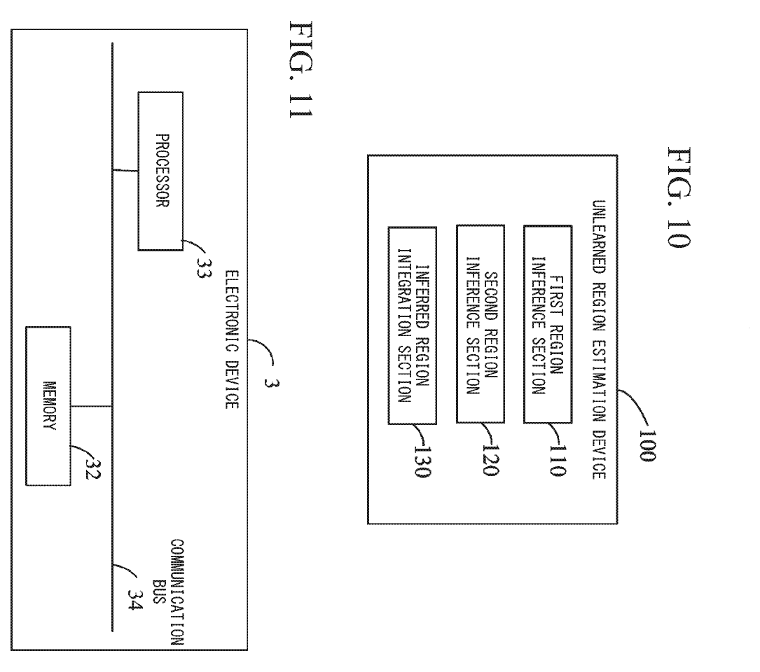

Exemplarily, as illustrated in FIG. 9, the plurality of region inference sections may include a first network model 91, a second network model 92, and a third network model 93. The inferred region integration section may include a gate model 94. Here, the first network model 91 is used to process an RGB image collected by a monocular camera, the second network model 92 is used to process point cloud data collected by a laser radar, and the third network model 93 is used to process a fisheye image collected by a fisheye camera. That is, each region inference section is a neural network model corresponding to a signal input thereto, and the inferred region integration section is a model capable of processing multi-modal input. The first network model 91 is used to perform target detection of a falling object on the RGB image collected by the monocular camera, and output a 2D target detection box corresponding to the RGB image. The second network model 92 is used to perform target detection of a falling object on point cloud data collected by a laser radar, and output a 3D target detection box corresponding to the point cloud data. The third network model 93is used to perform target detection of a falling object on a fisheye image collected by a fisheye camera, and output a 2D target detection box corresponding to the fisheye image. The multi-modal input of the gate model 94 is the RGB image collected by the monocular camera, the point cloud data collected by the laser radar, and the fisheye image collected by the fisheye camera. The gate model 94 is used to determine the distance between the electronic device and the falling object based on the multi-modal input, decide one or more target detection boxes based on the distance from the target detection boxes output by a plurality of models, merge the target detection boxes, and output the final object region of the falling object.

It should be noted that, in some embodiments, the first network model 91 may also simultaneously output a decision that the 2D target detection box corresponding to the RGB image and the 3D target detection box participate in the target detection box. The selection is specifically performed according to an actual situation, which is not limited in the embodiment of the present application.

It can be understood that the output of each sensor model has its advantages and disadvantages, and the inferred region integration section can automatically select an appropriate model output based on the distance between the electronic device and the falling object to determine the final object region of the falling object, thereby improving the detection accuracy of an obstacle or a falling object. Since each region inference section of the plurality of region inference sections, for example, each sensor model, may be implemented by using a lightweight model with high computing efficiency, and the inferred region integration section, for example, the gate model, may also be implemented by using a lightweight model, so that the plurality of region inference sections and the inferred region integration section may perform synchronous learning, for example, train all models at one time in a supervised training manner, thereby reducing computing resource consumption and improving network training efficiency.

An embodiment of the present application further provides an unlearned region estimation device, and FIG. 10 is a schematic structural diagram of an unlearned region estimation device according to the embodiment of the present application. As illustrated in FIG. 10, an unlearned region estimation device 100 includes a first region inference section 110, a second region inference section 120, and an inferred region integration section 130.

The first region inference section 110 infers an object region of a falling object based on an input signal,

the second region inference section 120 infers a region having a different feature from the first region inference section 110 based on a signal same as or different from the input signal, and

the inferred region integration section 130 integrates the regions inferred by the first region inference section 110 and the second region inference section 120, depending on a photographic scene.

In some embodiments, the unlearned region estimation device 100 further includes a region estimation unit, in which the inferred region integration section 130 includes an estimated region integrating unit,

the region estimation unit performs region estimation with two or more different features, and the estimated region integrating unit integrates a plurality of estimated regions.

In some embodiments, the inferred region integration section 130 further includes a photographic scene determination unit,

the photographic scene determination unit determines a scene of acquiring the input signal, and

the estimated region integrating unit integrates the estimated region based on an output from the photographic scene determination unit.

In some embodiments, the first region inference section 110 performs image segmentation based on the input signal to infer an object region of the falling object, and

the second region inference section 120 performs depth estimation based on a signal same as or different from the input signal to infer a region having a different feature from the first region inference section.

In some embodiments, the second region inference section 120 performs depth estimation based on a signal same as or different from the input signal to determine a depth value corresponding to a pixel, determines a target object based on the depth value corresponding to the pixel, and predicts normal vector information corresponding to the pixel, and determines a region corresponding to the target object using the normal vector information.

In some embodiments, the unlearned region estimation device 100 includes a mixture-of-experts model configured to integrate, by the inferred region integration section 130, the estimated regions output by the plurality of the region inference sections, depending on a photographic scene, the plurality of region inference sections including the first region inference section 110 and the second region inference section 120.

In some embodiments, the photographic scene determination unit determines a scene of the input signal based on a scene understanding algorithm.

In some embodiments, the unlearned region estimation device 100 includes a plurality of region inference sections, each configured to perform region estimation with two or more different features based on a signal input by itself.

In some embodiments, the input signal includes at least one type of signal data collected by at least one sensor, and the at least one sensor includes at least one of an image sensor and a lidar sensor.

It should be noted that the description of the foregoing device embodiments is similar to the description of the foregoing method embodiments, and has similar beneficial effects as the method embodiments. For technical details that are not disclosed in the device embodiments of the present application, refer to the description of the method embodiments of the present application.

An embodiment of the present application also provides an electronic device, and FIG. 11 is an optional schematic structural diagram of the electronic device according to the embodiment of the present application. As illustrated in FIG. 11, the electronic device 3 includes a memory 32 and a processor 33. The memory 32 and the processor 33 are connected through a communication bus 34, the memory 32 is used to store an executable instruction, and the processor 33 is used to execute the executable instruction stored in the memory 32 to implement the unlearned region estimation method provided by the embodiment of the present application.

An embodiment of the present application provides a computer-readable storage medium storing an executable instruction, in which the computer-readable storage medium stores an executable instruction, and when the executable instruction is executed by the processor, the processor is caused to perform the unlearned region estimation method provided by the embodiment of the present application.

In some embodiments, the computer-readable storage medium may be a ferroelectric random access memory (FRAM), a read-only memory (ROM), a programmable read only memory (PROM), an erasable programmable read only memory (EPROM), an electrically erasable programmable read only memory (EEPROM), a flash memory, a magnetic surface memory, an optical disc, or CD-ROM, or may be various devices including one or any combination of the memories.

In some embodiments, the executable instruction may be in a form of a program, software, a software module, a script, or a code, may be written in any form of programming languages (including compiled or interpreted languages, or declarative or procedural languages), and may be deployed in any form, including being deployed as an independent program or being deployed as a module, a component, a subroutine, or another unit suitable for use in a computing environment.

As an example, the executable instruction may, but do not necessarily, correspond to files in a file system, may be stored in a portion of a file that holds other programs or data, for example, in one or more scripts stored in a hyper text markup language (HTML) document, in a single file dedicated to the program in question, or in multiple coordinated files (for example, files that store one or more modules, sub programs, or portions of code). As an example, the executable instruction may be deployed to be executed on one computing device, executed on multiple computing devices located at one site, or executed on multiple computing devices distributed at multiple sites and interconnected by a communication network.

A person skilled in the art should understand that the embodiments of the present application may be provided as a method, a system, or an integrated program (computer program product). Therefore, the present application may use a form of a hardware embodiment, a software embodiment, or an embodiment combining software and hardware. In addition, the present application may be in a form of a computer program product implemented on one or more computer-usable storage media that include a computer-usable program code (including but not limited to magnetic disk memory, optical memory, and the like).

The present application is described with reference to flowchart illustrations and/or block diagrams of methods, devices (systems), and computer program products according to embodiments of the present application. It should be understood that each process and/or block in the flowcharts and/or block diagrams, and combinations of processes and/or blocks in the flowcharts and/or block diagrams may be implemented by computer program instructions. These computer program instructions may be provided to a processor of a general-purpose computer, a special-purpose computer, an embedded processor, or another programmable data processing device to generate a machine, so that the instructions executed by the processor of the computer or other programmable data processing devices generate a device for implementing functions specified in one or more processes in the flowcharts and/or one or more blocks in the block diagrams.

These computer program instructions may also be stored in a computer-readable memory that can guide a computer or another programmable data processing device to work in a specific manner, so that an instruction stored in the computer-readable memory generates an article of manufacture including an instruction device, and the instruction device implements a function specified in one or more processes in the flowcharts and/or one or more blocks in the block diagrams.

These computer program instructions may also be loaded onto a computer or other programmable data processing devices to cause a series of operational steps to be performed on the computer or other programmable devices to produce a computer-implemented process such that the instructions executed on the computer or other programmable devices provide steps for implementing the functions specified in one or more processes of the flowcharts and/or one or more blocks of the block diagrams.

The foregoing descriptions are merely preferred embodiments of the present application, and are not intended to limit the protection scope of the present application. Any modifications, equivalent substitutions, and improvements made within the spirit and scope of the present application are included within the protection scope of the present application.

What is claimed is:

1. An unlearned region estimation device comprising:
a first region inference section configured to infer an object region of a falling object based on an input signal;
a second region inference section configured to infer a region having a different feature from the first region inference section based on a signal same as or different from the input signal; and
an inferred region integration section configured to integrate the regions inferred by the first region inference section and the second region inference section, depending on a photographic scene.

2. The device according to claim 1, further comprising:
a region estimation unit, wherein
the inferred region integration section includes an estimated region integrating unit,
the region estimation unit performs region estimation with two or more different features, and
the estimated region integrating unit integrates a plurality of estimated regions.

3. The device according to claim 2, wherein
the inferred region integration section further includes a photographic scene determination unit,
the photographic scene determination unit determines a scene of acquiring the input signal, and
the estimated region integrating unit integrates the estimated regions based on an output from the photographic scene determination unit.

4. The device according to claim 1, wherein
the first region inference section performs image segmentation based on the input signal to infer an object region of the falling object, and
the second region inference section performs depth estimation based on a signal same as or different from the input signal to infer a region having a different feature from the first region inference section.

5. The device according to claim 4, wherein
the second region inference section
performs depth estimation based on a signal same as or different from the input signal to determine a depth value corresponding to a pixel,
determines a target object based on the depth value corresponding to the pixel, and predicts normal vector information corresponding to the pixel, and
determines a region corresponding to the target object using the normal vector information.

6. The device according to claim 1, further comprising:
a mixture-of-experts model configured to integrate, by the inferred region integration section, the estimated regions output by the plurality of the region inference sections, depending on a photographic scene, the plurality of region inference sections including the first region inference section and the second region inference section.

7. The device according to claim 3, wherein
the photographic scene determination unit determines the scene of the input signal based on a scene understanding algorithm.

8. The device according to claim 2, further comprising:
a plurality of region inference sections, each configured to perform region estimation with two or more different features based on a signal input by itself.

9. The device according to claim 1, wherein
the input signal includes at least one type of signal data collected by at least one sensor, and the at least one sensor includes at least one of an image sensor and a lidar sensor.

10. An unlearned region estimation method comprising:
a step of inferring, by a first region inference section, an object region of a falling object based on an input signal;
a step of inferring, by a second region inference section, a region having a different feature from the first region inference section based on a signal same as or different from the input signal; and
a step of integrating, by the inferred region integration section, the regions inferred by the first region inference section and the second region inference section, depending on a photographic scene.

11. The method according to claim 10, further comprising:
a step of performing, by a region estimation unit, region estimation with two or more different features; and
a step of integrating a plurality of estimated regions by an estimated region integrating unit in the inferred region integration section.

12. The method according to claim 11, wherein
the inferred region integration section further includes a photographic scene determination unit, and
the step of integrating a plurality of estimated regions includes
a step of determining a scene of acquiring the input signal, and
a step of integrating, by the estimated region integrating unit, the estimated regions based on an output from the photographic scene determination unit.

13. The method according to claim 10, wherein
the step of inferring an object region of a falling object based on the input signal includes
a step of performing image segmentation based on the input signal to infer an object region of a falling object, and
the step of inferring a region having a different feature from the first region inference section based on a signal same as or different from the input signal includes
a step of performing depth estimation based on a signal same as or different from the input signal to infer a region having a different feature from the first region inference section.

14. The method according to claim 13, wherein
the step of performing depth estimation based on a signal same as or different from the input signal to infer a region having a different feature from the first region inference section includes
a step of performing depth estimation based on a signal same as or different from the input signal to determine a depth value corresponding to a pixel,
a step of determining a target object based on the depth value corresponding to the pixel, and predicting normal vector information corresponding to the pixel, and
a step of determining a region corresponding to the target object using the normal vector information.

15. The method according to claim 12, wherein
the step of determining a scene of acquiring the input signal includes
a step of determining a scene of the input signal based on a scene understanding algorithm.

16. An electronic device comprising:
a memory; and
a processor, wherein
the memory stores an executable instruction, and
the processor executes the executable instruction stored in the memory to implement the method according to claim 10.

17. A computer-readable storage medium storing an executable instruction, wherein
the executable instruction is executed by a processor to implement the method according to claim 10.

18. An integrated program comprising: a computer-executable instruction, wherein
the computer-executable instruction is executed by a processor to implement the method according to claim 10.
